(19) United States
(12) Patent Application Publication
(10) Pub. No.: US 2006/0202912 A1
(43) Pub. Date: Sep. 14, 2006

(54) Plasma display apparatus

(76) Inventor: Dong-Hyok Shin, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/361,617

(22) Filed: Feb. 24, 2006

(30) Foreign Application Priority Data
Mar. 8, 2005 (KR) 10-2005-0019060

(51) Int. Cl. G09G 3/10

(52) U.S. Cl. 345/37

(57) ABSTRACT

A plasma display apparatus including a unit for reinforcing a coupling force of a boss to a chassis is disclosed. In one embodiment, the apparatus includes: a chassis disposed on a side of a plasma display panel displaying images using a gas discharge, and supporting the plasma display panel, a boss coupled to the chassis and a reinforcing unit reinforcing the coupling structure between the chassis and the boss. According to one embodiment, the coupling structure between the bosses, which support the circuit board, and the chassis can be reinforced, and thus, the bosses are not separated from the chassis and the plasma display apparatus can operate stably.

### CROSS-REFERENCE TO RELATED PATENT APPLICATIONS

This application claims the benefit of Korean Patent Application No. 10-2005-0019060, filed on Mar. 8, 2005, in the Korean Intellectual Property Office, the disclosure of which is incorporated herein in its entirety by reference.

### BACKGROUND OF THE INVENTION

1. Field of the Invention

The present invention relates to a plasma display apparatus, and more particularly, to a plasma display apparatus having a unit for reinforcing a coupling force of a boss to a chassis.

2. Description of the Related Technology

Plasma display apparatuses are flat panel display apparatus displaying images using a gas discharge. In addition, plasma display apparatuses are considered to be the flat panel display apparatuses of next generation since they can have a thin profile, high image quality, and a wide viewing angle all in conjunction with large screen size.

A plasma display apparatus generally includes a plasma display panel displaying images using the gas discharge, and a chassis supporting the plasma display panel. In addition, the chassis includes a plurality of circuit boards, on which circuit devices driving the plasma display panel to display images are disposed. The circuit boards are coupled to the chassis using bosses formed on the chassis.

FIG. 1 is a cross-sectional view of a coupling structure between the chassis and one of the bosses in the conventional plasma display apparatus. Referring to FIG. 1, the boss 170 is forcibly inserted into a hole 121 formed on the chassis 120. In addition, the circuit board 150 and the boss 170 are coupled to each other using a screw 175. In FIG. 1, the boss 170 is forcibly inserted into the hole 121. The boss 170 includes a step 171 at a lower portion thereof so as to be coupled to the chassis 120 at a required length. Bosses used in the plasma display apparatus can have different lengths and structures according to shapes of the circuit board and the chassis, which the bosses support.

However, the bosses that are forcibly inserted into the chassis in the conventional plasma display apparatus may not be coupled with sufficient strength, and thus, the bosses may escape from the chassis when operating the plasma display apparatus.

In addition, some of the bosses coupled to the chassis 120 do not support the circuit board 150, but may fix the plasma display apparatus onto a wall. The bosses (not shown) for fixing the plasma display apparatus on the wall have more loads, and thus, a large local load may be transmitted to the plasma display panel through the chassis. Therefore, the plasma display panel may be damaged due to the local load.

### SUMMARY OF CERTAIN INVENTIVE ASPECTS

One aspect of the present invention provides a plasma display apparatus including a coupling structure between a boss that supports circuit boards and a chassis in order to prevent the boss from being loosen or escaped from the chassis.

Another aspect of the present invention provides a plasma display apparatus including a coupling structure between a boss and a chassis so as to prevent the boss, which fixes the plasma display apparatus onto a wall, from being loosen or escaped from the chassis.

Another aspect of the present invention provides a plasma display apparatus including a coupling structure between a boss and a chassis so as to ensure sufficient coupling force even when the chassis is thin.

Another aspect of the present invention provides a plasma display apparatus including: a chassis disposed on a side of a plasma display panel displaying images using a gas discharge, and supporting the plasma display panel, a boss coupled to the chassis and a reinforcing unit reinforcing the coupling structure between the chassis and the boss.

In one embodiment, the reinforcing unit may be a screw coupled to the boss by penetrating the chassis.

In one embodiment, a washer may be disposed between a head of the screw and the boss.

In one embodiment, the washer may be formed of an elastic material.

In one embodiment, a portion of the chassis, to which the screw is coupled, may be depressed so that the screw does not protrude from a surface of the chassis coupled to the plasma display panel.

In one embodiment, the reinforcing unit may be a rivet that is coupled to the boss after penetrating the chassis.

In one embodiment, a portion of the chassis, to which the rivet is coupled, may be depressed so that the rivet does not protrude from a surface of the chassis coupled to the plasma display panel.

In one embodiment, the circuit board, on which circuit devices driving the plasma display panel are disposed, may be coupled to the chassis by the boss. The boss may fix the plasma display apparatus onto a certain area.

### BRIEF DESCRIPTION OF THE DRAWINGS

Embodiments of the present invention will become more apparent by describing in detail exemplary embodiments thereof with reference to the attached drawings.

FIG. 1 is a cross-sectional view of a part of a coupling structure between a chassis and a boss in a conventional plasma display apparatus.

FIG. 2 is an exploded perspective view of a plasma display apparatus according to an embodiment of the present invention.

FIG. 3 is a cross-sectional view of a coupling structure between a chassis and a boss in the plasma display apparatus of FIG. 2.

FIG. 4 is a cross-sectional view of another example of coupling structure between the chassis and the boss in the plasma display apparatus of FIG. 2.

### DETAILED DESCRIPTION OF CERTAIN INVENTIVE EMBODIMENTS

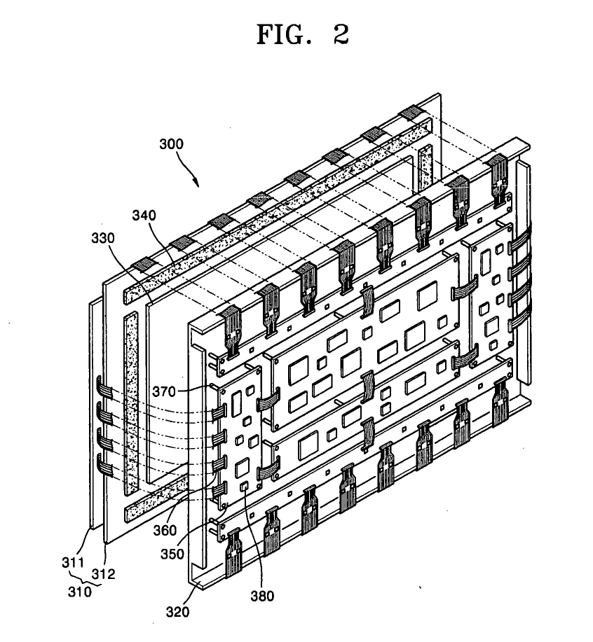

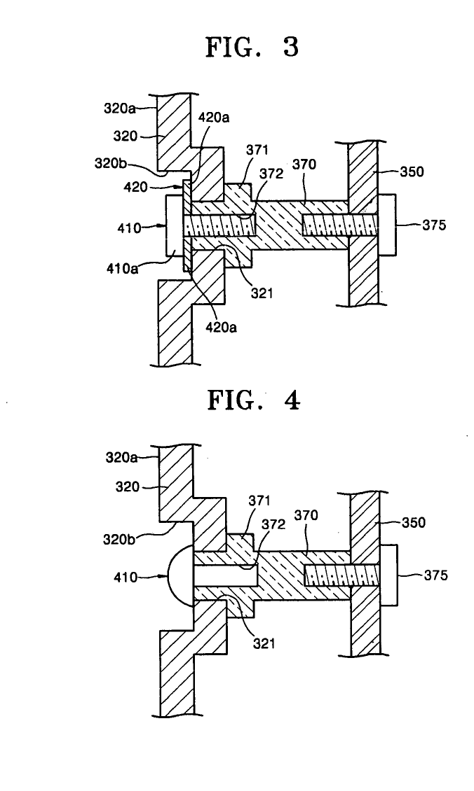

FIG. 2 is an exploded perspective view of a plasma display apparatus according to an embodiment of the present invention, and FIG. 3 is a cross-sectional view of a coupling structure between a chassis and a boss in the plasma display apparatus of FIG. 2.

Referring to FIGS. 2 and 3, the plasma display apparatus 300 includes a plasma display panel 310 including a front substrate 311 and a rear substrate 312. The plasma display panel 310 is supported by a chassis 320 that is generally formed of a metal material such as aluminum. In addition, the plasma display panel 310 is coupled to the chassis 320 generally using a dual-adhesive tape 340. A thermal conductive sheet 330 is disposed between the plasma display panel 310 and the chassis 320 to transmit heat generated by the plasma display panel 310 to the chassis 320 and dissipate the heat.

A plurality of circuit boards 350, on which a plurality of circuit devices 380 driving the plasma display panel 310 are mounted, are disposed on a rear surface of the chassis 320. The circuit boards 350 are connected to the plasma display panel 310 through signal transmission units 360 such as tape carrier packages (TCPs). In addition, the circuit boards 350 are fixed on the chassis 320 using bosses 370 coupled to the chassis 320.

In one embodiment, the plasma display panel 310, the chassis 320, and the circuit boards 350 may be accommodated in a case (not shown).

FIG. 3 illustrates a coupling structure between the chassis 320 and each of the bosses 370. In one embodiment, the boss 370 is coupled to a boss hole 321 formed on the chassis 320 using a forcible insertion method or a spinning method. In one embodiment, the boss 370 includes a step 371 at a lower portion thereof so as to be coupled to the chassis 320 to a required length. In one embodiment, a screw 410 having a head 410a that has a larger diameter than that of the boss hole 321 of the chassis 320 is coupled to a screw portion 372 that is formed along a center axis of the boss 370. In another embodiment, the head 410a of the screw 410 may have a smaller diameter than that of the boss hole 321 of the chassis 320. As described above, since the boss 370 is additionally coupled to the chassis 320 using the screw 410, the coupling force of the boss 370 to the chassis 320 increases and the boss 370 can be firmly coupled to the chassis 320. Moreover, if the head 410a of the screw 410 has the larger diameter than that of the boss hole 321 of the chassis 320, the head 410a can completely prevent the boss 370 from being escaped from the chassis 320.

In one embodiment, a washer 420 is disposed between the head 410a of the screw 410 and the chassis 320. The washer 420 may have a diameter larger than that of the head 410a of the screw 410 or the boss hole 321 of the chassis 320. That is, the washer 420 may have a large area so that an edge 420a of the washer 420 can contact the chassis 320. The washer 420 can distribute the stress concentrated on the screw 410 to the chassis 320, and makes the screw 410 adhered to the chassis 320 to fix the boss 370 firmly on the chassis 320.

In one embodiment, the washer 420 may be formed of an elastic material in order to reduce noise generated when operating the plasma display apparatus 300.

In another embodiment, the washer 420 may be omitted. In this embodiment, the coupling force of the boss 370 to the chassis 320 can be reinforced without the washer 420.

In one embodiment, a portion of the chassis 320, on which the screw 410 and the boss hole 321 are formed, has a depressed portion 320b so that the screw 410 does not protrude from a front surface 320a of the chassis 320, that is, the surface to which the plasma display panel is attached. Although it is not shown in the drawing, the front surface 320a of the chassis 320 contacts the thermal conductive sheet 330 or the dual-adhesive tape 340 by surface, and thus, the contacting surface should be flat. Therefore, the chassis 320 is depressed backward to a predetermined depth, for example, to a height of the head 410a of the screw 410 or deeper, so that the screw 410 does not protrude from the front surface 320a of the chassis 320 when the screw 410 is coupled to the chassis 320.

The circuit board 350 is coupled to the other end of the boss 370 using another screw 375. In the FIG. 3 embodiment, the boss 370 is coupled to the circuit board 350. In another embodiment, the boss may be a boss or there may be another bosses for fixing the plasma display apparatus 300 on a certain space such as a wall.

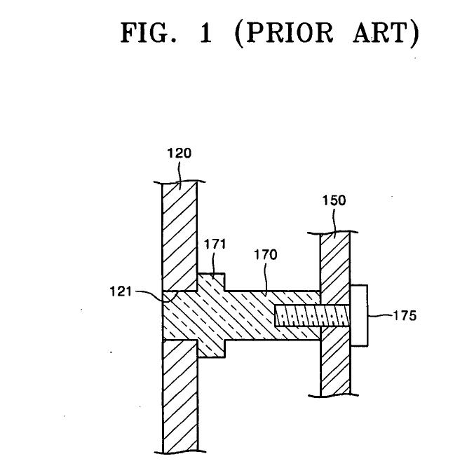

FIG. 4 is a cross-sectional view of another example of the coupling structure between the chassis and the boss in the plasma display apparatus of FIG. 2. Referring to FIG. 4, the chassis 320 and the boss 370 are coupled to each other using a rivet 450 instead of the screw. According to this structure, assembling process is simple when it is compared to the coupling structure between the chassis and the boss of FIG. 1.

According to one embodiment, the coupling structure between the bosses, which support the circuit board, and the chassis can be reinforced, and thus, the bosses are not escaped from the chassis and the plasma display apparatus can operate stably.

In addition, the coupling structure between the bosses, which fix the plasma display apparatus onto the wall, and the chassis can be reinforced, and thus, the bosses are not separated from the chassis and the plasma display apparatus can be stably positioned.

In addition, even when the chassis is thin, the sufficient coupling force between the chassis and bosses can be obtained.

Moreover, the thickness of the chassis can be formed thinner than that of the conventional art, and thus, fabrication costs of the chassis can be reduced.

While the above description has pointed out novel features of the invention as applied to various embodiments, the skilled person will understand that various omissions, substitutions, and changes in the form and details of the device or process illustrated may be made without departing from the scope of the invention. Therefore, the scope of the invention is defined by the appended claims rather than by the foregoing description. All variations coming within the meaning and range of equivalency of the claims are embraced within their scope.

What is claimed is:

1. A plasma display apparatus, comprising:
a chassis, having first and second surfaces, wherein the second surface opposes the first surface, and wherein the first surface of the chassis supports a plasma display panel;
a boss coupled to the second surface of the chassis; and
a reinforcing unit contacting the chassis and the boss.

2. The apparatus of claim 1, wherein the reinforcing unit is a screw inserted into the boss.

3. The apparatus of claim 2, wherein the reinforcing unit includes a washer formed between a head of the screw and the boss.

4. The apparatus of claim 3, wherein the washer is formed of an elastic material.

5. The apparatus of claim 2, wherein a portion of the first surface of the chassis is depressed toward the second surface so that the screw does not protrude from the first surface.

6. The apparatus of claim 1, wherein the reinforcing unit is a rivet inserted into the boss.

7. The apparatus of claim 6, wherein a portion of the first surface of the chassis is depressed toward the second surface so that the rivet does not protrude from the first surface.

8. The apparatus of claim 1, further comprising a circuit board which includes a plurality of circuit devices configured to drive the plasma display panel, wherein the circuit board is coupled to the chassis by the boss.

9. The apparatus of claim 1, wherein the boss is configured to fix the plasma display apparatus onto a certain area.

10. The apparatus of claim 1, wherein the reinforcing unit is formed on the first surface of the chassis.

11. A plasma display apparatus, comprising:
a chassis, defining a throughhole, configured to receive a boss from one end of the throughhole; and
a fastener inserted into the boss from the other end of the throughhole.

12. The apparatus of claim 11, wherein the fastener is a screw or a rivet.

13. The apparatus of claim 12, wherein at least one of the screw and rivet heads is larger than the diameter of the throughhole.

14. The apparatus of claim 11, wherein a portion of the first surface of the chassis is depressed toward the second surface so that the fastener does not protrude from the first surface.

15. The apparatus of claim 11, further comprising at least one circuit board which includes a plurality of circuit devices configured to drive a plasma display panel, wherein the at least one circuit board is coupled to the chassis by the boss.
